(19) United States
(12) Patent Application Publication
(10) Pub. No.: US 2022/0291114 A1
(43) Pub. Date: Sep. 15, 2022

(54) SETUP FOR SIMULATING CORROSION OF MATERIALS UNDER REFINERY CONDITIONS

(71) Applicant: ABU DHABI OIL REFINING COMPANY - TAKREER, Abu Dhabi (AE)

(72) Inventors: Mabruk Issa SULEIMAN, Abu Dhabi (AE); Mohamed AL MUSHARFY, Abu Dhabi (AE); Mohammad Abdur RAKIB, Abu Dhabi (AE)

(21) Appl. No.: 17/629,876

(22) PCT Filed: Aug. 2, 2019
(86) PCT No.: PCT/IB2019/056606

§ 371 Date: Jan. 25, 2022

(51) Int. Cl. G01N 17/04

(52) U.S. Cl. CPC G01N 17/043

(57) ABSTRACT

An apparatus for testing corrosiveness of liquid feedstock includes a feed preparation section (A) for pre-treating the liquid feedstock; a feed treatment section (B) downstream of the feed preparation section (A) for treating the pre-treated liquid feedstock at elevated temperature; a separation section (C) downstream of the feed treatment section (B) for separating a liquid portion from a vaporous portion at a temperature lower than the elevated temperature of the feed treatment section (B); a product analysis section (D) downstream of the separation section for analysing the amount of corrosive species in the liquid portion ; and one or more corrosion coupons (1-9). The corrosion coupons (1-9) are placed into one or more of the feed preparation section (A), the feed treatment section (B), the separation section (C) or the product analysis section (D) such that the corrosion coupons are in contact with the liquid feedstock during operation.

The present invention relates to an apparatus and process suitable for simulating corrosion of refinery processes under operating conditions.

### BACKGROUND ART

Petroleum refining processes include a variety of chemical engineering processes to transform crude oil into useful products such as liquefied petroleum gas (LPG), gasoline, kerosene, jet fuel, diesel oils, fuel oils.

These chemical engineering processes partly require high operating temperatures and pressures, partly the presence of corrosive reactants and a vast pipeline to transport process fluids throughout the site and eventually to external modes of transport. Additionally, the crude oil itself can contain various amounts of corrosive species, such as sulphur containing compounds.

Thus, the chemical engineering processes of a petroleum refinery unit are prone to different sources of corrosion, which are difficult to predict.

At the same time petroleum refining is also a high hazard industry with most sites processing thousands of tonnes of oil into various product lines each year many of which are flammable, toxic to human health or toxic to the environment.

This combination of factors make refinery units very vulnerable to a variety of corrosion phenomena that can eventually cause a loss of containment of process fluids, sometimes leading to a serious accident affecting workers, the environment, the surrounding economy and even on occasion the larger economy.

Several attempts have been made to simulate corrosion of chemical processes.

U.S. Pat. Nos. 5,425,267 and 5,503,006 disclose setups for monitoring corrosion of high temperature liquid streams with respect to temperature and hydrodynamics. However, the setups are not related to refinery processes and their operating conditions.

U.S. Pat. No. 8,084,267 discloses a setup for monitoring corrosion in which liquid feedstock is circulated in a reactor vessel at a pre-set temperature with corrosion coupons placed into the reactor vessel. The setup, however, is a closed recirculation system in which the reactants are not replenished and is therefore not related to refinery processes and their operating conditions.

U.S. Pat. No. 4,267,148 discloses a setup for monitoring corrosion of liquid feedstock in production tubulars in oil and gas wells. This setup, however, does not capture refinery processes and their operating conditions.

Thus, although in principle methods and setups are known in the art of how to simulate and predict corrosion in chemical processes there is a need in the art for setups specifically for refinery processes.

### SUMMARY OF THE INVENTION

The present invention relates to an apparatus for testing corrosiveness of liquid feedstock comprising:

feed preparation section (A) for pre-treating the liquid feedstock;

a feed treatment section (B) downstream the feed preparation section (A) for treating the pre-treated liquid feedstock at elevated temperature;

a separation section (C) downstream the feed treatment section (B) for separating a liquid portion of the treated liquid feedstock from a vaporous portion of the treated liquid feedstock at a temperature lower than the elevated temperature of the feed treatment section (B);

a product analysis section (D) downstream the separation section for analysing the amount of corrosive species in the liquid portion of the treated liquid feedstock and optionally in the vaporous portion of the treated liquid feedstock;

a plurality of feeding lines (E) for feeding the liquid feedstock from the feed preparation section (A) to the feed treatment section (B) to the separation section (C) and to the product analysis section (D); and

one or more corrosion coupons (1-9);

wherein the one or more corrosion coupons (1-9) are removably placed into one or more of the feed preparation section (A), the feed treatment section (B), the separation section (C) and/or the product analysis section (D) as such that the one or more corrosion coupons are in contact with the liquid feedstock during operation of the apparatus.

Further, the present invention relates to a process for testing corrosiveness of liquid feedstock comprising the following steps:
a) pre-treating the liquid feedstock;
b) treating the pre-treated liquid feedstock at elevated temperature;
c) separating a liquid portion of the treated liquid feedstock from a vaporous portion of the treated liquid feedstock at a temperature lower than the elevated temperature of treatment step b);
d) analysing the amount of corrosive species in the liquid portion of the treated liquid feedstock and optionally in the vaporous portion of the treated liquid feedstock; wherein
e) in one or more of process steps a) to d) the liquid feedstock is contacted with one or more corrosion coupons and
f) after a testing cycle the weight loss of the one or more corrosion coupons is measured.

Still further, the present invention relates to the use the apparatus as defined above or below and/or the process as defined above or below for simulating corrosion of refinery processes under operating conditions.

The apparatus and process according to the invention are especially suitable for simulating corrosion of petroleum refinery processes under operating conditions. Thereby, the apparatus and process are capable of operating with various feedstocks at refinery stream process conditions in order to test different metals and alloys for corrosion tendencies in different process environments and feed quality.

Thus, the apparatus and process according to the invention are adapted to simulate the different corrosion phenomena in a variety of chemical engineering processes of a petroleum refinery unit and help to predict corrosion hot-spots and potential failures in the different reaction sites of a petroleum refinery unit.

### FIGURES

FIG. 1 shows a diagrammic view of an apparatus for testing corrosiveness of liquid feedstock according to the invention illustrating the different sections which simulate the chemical engineering processes of a petroleum refinery unit and showing the different spots for placing corrosion coupons.

FIG. 2 shows a schematic drawing of an example for a corrosion coupon holding structure in which corrosion coupons can be positioned in different angles in an isometric total view (a), and the holding parts of the holding structure in a front view (b), top view (c) and an isometric view (d).

### DETAILED DESCRIPTION

### Apparatus

The present invention relates to an apparatus for testing corrosiveness of liquid feedstock comprising:

a feed preparation section (A) for pre-treating the liquid feedstock;

a feed treatment section (B) downstream the feed preparation section (A) for treating the pre-treated liquid feedstock at elevated temperature;

a separation section (C) downstream the feed treatment section (B) for separating a liquid portion of the treated liquid feedstock from a vaporous portion of the treated liquid feedstock at a temperature lower than the elevated temperature of the feed treatment section (B);

a product analysis section (D) downstream the separation section for analysing the amount of corrosive species in the liquid portion of the treated liquid feedstock and optionally in the vaporous portion of the treated liquid feedstock;

a plurality of feeding lines for feeding the liquid feedstock from the feed preparation section (A) to the feed treatment section (B) to the separation section (C) and to the product analysis section (D); and

one or more corrosion coupons (1-9);

wherein the one or more corrosion coupons (1-9) are removably placed into one or more of the feed preparation section (A), the feed treatment section (B), the separation section (C) and/or the product analysis section (D) as such that the one or more corrosion coupons are in contact with the liquid feedstock during operation of the apparatus.

The feed preparation section preferably comprises a vessel (A-1) for storing liquid feedstock, a vessel (A-2) for storing further components, means (A-3) for mixing and preheating the liquid feedstock and the further components and means (A-4) for controlling flow rate of the further components.

The vessel (A-1) for storing liquid feedstock can comprise means for calibrating the amount of liquid feedstock to be fed into the apparatus.

The vessel (A-1) for storing liquid feedstock is preferably connected with the means (A-3) for mixing and preheating the liquid feedstock by means of a feeding line. Preferably the liquid feedstock is fed into the means (A-3) for mixing and preheating the liquid feedstock by means of a metered conveying unit such as a pump.

The vessel (A-2) for storing other components can comprise means for calibrating the amount of the other components to be fed into the apparatus.

The vessel (A-2) for storing other components is preferably connected with the feeding line for conveying the liquid feedstock by means of at least one additional feeding line. Said additional feeding line can be connected with the feeding line for conveying the liquid feedstock at different positions of the apparatus depending on the process which shall be simulated. One possible position is upstream of the means (A-3) for mixing and preheating the liquid feedstock. Another suitable position is between the means (A-3) for mixing and preheating the liquid feedstock and the isothermal treatment unit (B-1). Still another suitable position is in counterflow mode to the liquid feedstock stream at the other end of the isothermal treatment unit (B-1).

The additional feeding line for conveying the other components preferably comprises a flow controlling unit (A-4) such as a flow valve for metering the flow of the other components into the feeding line for conveying the liquid feedstock. For simulating certain processes no additional components are introduced into the feeding line for conveying the liquid feedstock.

For these modes the additional feeding line for conveying the other components preferably is closed by means of the flow controlling unit (A-4).

The means (A-3) for mixing and preheating the liquid feedstock preferably is a preheating unit such as a tubular preheating unit which is preferably surrounded by means for controlling the temperature in the means (A-3) for mixing and preheating the liquid feedstock, like a heater block, preferably an electric heater block.

The means (A-3) for mixing and preheating the liquid feedstock is preferably connected with the feed treatment section (B) by means of a feeding line.

The feed treatment section (B) preferably comprises an isothermal treatment unit (B-1), means for controlling the temperature in the isothermal treatment unit (B-1), and means for controlling the pressure in the isothermal treatment unit (D-1).

Preferably the isothermal treatment unit (B-1) is a reactor unit, preferably a tubular reactor unit. The isothermal treatment unit (B-1) preferably is connected with the feed preparation section (A), preferably the means (A-3) for mixing and preheating the liquid feedstock, by means of a feeding line. Said feeding line can be connected with the isothermal treatment unit (B-1) at different positions of the isothermal treatment unit (B-1) depending on the process which shall be simulated. One suitable position can be the upper part of the isothermal treatment unit (B-1) as to obtain a downflow of the liquid feedstock in the isothermal treatment unit (B-1). Another suitable position can be the lower part of the isothermal treatment unit (B-1) as to obtain an upflow of the liquid feedstock in the isothermal treatment unit (B-1).

Preferably, the isothermal treatment unit (B-1) is filled with a packing (B-2) for evenly distributing the pre-treated liquid feedstock along the isothermal treatment unit (B-1). Said packing (B-2) can either be a non-reactive packing for a non-reactive heat treatment of the liquid feedstock in the isothermal treatment unit (B-1) or a reactive packing for a reactive heat treatment of the liquid feedstock in the isothermal treatment unit (B-1). The reactive packing preferably comprises a catalyst suitable for catalysing the accordant reactive heat treatment of the liquid feedstock and for catalytically treating the liquid feedstock. The packing (B-2) preferably is composed of an appropriate material for the treatment to be simulated. It is preferred that either the packing (B-2) in the isothermal treatment unit (B-1) is exchangeable or that the isothermal treatment unit (B-1) including a non-exchangeable packing is exchangeable in the apparatus of the invention so that the packing can be adjusted and exchanged for each process to be simulated.

The temperature of the isothermal treatment unit (B-1) is preferably controlled by means of means for controlling the temperature in the isothermal treatment unit (B-3). Said means for controlling the temperature in the isothermal treatment unit (B-3) are preferably surrounding the isothermal treatment unit (B-3), such as a heater block, preferably an electric heater block, surrounding the tubular reactor unit.

The pressure of the isothermal treatment unit (B-1) is preferably controlled by means for controlling the pressure in the isothermal treatment unit (D-1). Said means for controlling the pressure in the isothermal treatment unit (D-1) are not necessarily situated in the feed treatment section (B). Suitably the means for controlling the pressure in the isothermal treatment unit (D-1) is also used for controlling the pressure in the separating section (C). In this embodiment the means for controlling the pressure in the isothermal treatment unit (D-1) can also be situated downstream of the separating section (C) such as in the product analysis section (D). Suitably the means for controlling the pressure in the isothermal treatment unit (D-1) is a valve.

The isothermal treatment unit (B-1) preferably is connected with the separating section (C) by means of a feeding line. The feeding line for connecting the isothermal treatment unit (B-1) and the separating section (C) is preferably situated on the other end of the isothermal treatment unit (B-1) with respect to the feeding line for connecting the isothermal treatment unit (B-1) and the feed preparation section (A).

The separation section (C) preferably comprises at least one separating unit (C-1).

The separating unit (C-1) is preferably is connected with the isothermal treatment unit (B-1) by means of a feeding line.

The separating unit (C-1) is preferably a separating unit suitable to separate a liquid portion of the treated feedstock for a vaporous portion of the treated feedstock. Thus, the separating unit (C-1) preferably is a vapour/liquid separator.

The separating unit (C-1) is preferably connected with a storing unit (C-2) for storing treated liquid feedstock by means of a feeding line.

Further, the separating unit (C-1) is preferably connected with a second separating unit (C-3) by means of a feeding line.

The second separating unit (C-3) is preferably suitable for separating a liquid portion from a vaporous portion from the vaporous portion of the treated feedstock which has been separated in the separating unit (C-1). Preferably, the second separating unit (C-3) is a knockout pot.

Preferably the second separating unit (C-3) is connected with the storing unit (C-2) for storing treated liquid feedstock by means of a feeding line for conveying the liquid portion from the second separating unit to the storing unit (C-2).

Further, the second separating unit (C-3) is preferably connected with the product analysis section (D) by means of a feeding line for conveying the vaporous portion from the second separating unit (C-3) to the product analysis section (D).

It is preferred that the means for controlling the pressure in the isothermal treatment unit (D-1) is situated in the feeding line for conveying the vaporous portion from the second separating unit (C-3) to the product analysis section (D) downstream the second separating unit (C-3).

In the product analysis section (D) the amount of corrosive species in the liquid portion of the treated liquid feedstock and optionally in the vaporous portion of the treated liquid feedstock is analysed.

For analysing the amount of corrosive species in the liquid portion of the treated liquid feedstock the product analysis section (D) preferably comprises analysing units for detecting the amounts of total sulphur and of mercaptans sulphur in the treated liquid feedstock.

For analysing the amount of corrosive species in the vaporous portion of the treated liquid feedstock the product analysis section (D) preferably comprises at least one means (D-2) for monitoring the gas flow of the vaporous portion of the treated feedstock, such as a flow meter or a wet gas meter.

It is preferred that the means (D-2) for monitoring the gas flow of the vaporous portion of the treated feedstock is situated in the in the feeding line for conveying the vaporous portion from the second separating unit (C-3) to the product analysis section (D), preferably downstream the means for controlling the pressure in the isothermal treatment unit (D-1).

The product analysis section (D) can further comprise a flue gas sweetener (D-3) such as an amine gas treating unit or an adsorption bed for removing H₂S from the vaporous portion of the treated feedstock. The flue gas sweetener (D-3) is preferably situated downstream of the means (D-2) for monitoring the gas flow of the vaporous portion of the treated feedstock.

For analysing the amount of corrosive species in the vaporous portion of the treated liquid feedstock the product analysis section (D) preferably comprises at least one analysing unit for detecting the amounts of vaporous sulphur species such as H₂S in the vaporous portion of the treated liquid feedstock, like a gas chromatograph.

The apparatus according to the present invention further comprises one or more corrosion coupons (1-9) which can be removably placed into one or more of the feed preparation section (A), the feed treatment section (B), the separation section (C) and/or the product analysis section (D) as such that the one or more corrosion coupons are in contact with the liquid feedstock during operation of the apparatus.

Suitable positions for placed the at least one corrosion coupons are the means (A-3) for mixing and preheating the liquid feedstock, the isothermal treatment unit (B-1), the feeding line connecting the means (A-3) for mixing and preheating the liquid feedstock and the isothermal treatment unit (B-1), the feeding line connecting the isothermal treatment unit (B-1) and the separating unit (C-1), the separating unit (C-1), the second separating unit (C-3) and the feeding line for conveying the vaporous portion from the second separating unit (C-3) to the product analysis section (D) downstream the second separating unit (C-3).

It is preferred that a plurality of corrosion coupons are removably placed into each section (A), (B), (C) and (D) of the apparatus of the present invention.

It is preferred that two or more corrosion coupons are removably positioned into a corrosion coupon holding structure which extends in x-, y- and z-direction as such that the two or more corrosion coupons are fixed at the same height in z-direction and are arranged at different angles in x- and y-directions and at least one corrosion coupon holding structure is removably placed into one or more of the feed preparation section (A), the feed treatment section (B), the separation section (C) and/or the product analysis section (D) as such that the two or more corrosion coupons in the corrosion coupon structure are in contact with the liquid feedstock during operation of the apparatus.

The corrosion coupon holding structure can have any dimensions and form suitable for holding and fixing two or more, such as 2, 3, 4, 5, 6, 7 or 8, corrosion coupons at the same height in z-direction and at different angles in x- and y-directions. Preferably the corrosion coupon holding structure comprises an upper and a lower holding unit into which the corrosion coupons are placed and secured in a shape so that the angle between the corrosion coupons in x-y dimensions is fixed. Suitable angles in x- and y-directions are selected e.g. from 45°, 51.4°, 60°, 72°, 90°, 120° or 180°, preferably from 45°, 60°, 90° or 120°, more preferably from 90° or 120° mostly preferred from 90°.

In one preferred embodiment three corrosion coupons are removably positioned into a corrosion coupon holding structure in a shape so that the angle between the corrosion coupons in x-y dimensions is 120°.

In another preferred embodiment six corrosion coupons are removably positioned into a corrosion coupon holding structure in a shape so that the angle between the corrosion coupons in x-y dimensions is 60°.

In still another preferred embodiment eight corrosion coupons are removably positioned into a corrosion coupon holding structure in a shape so that the angle between the corrosion coupons in x-y dimensions is 45°.

In yet another preferred embodiment four corrosion coupons are removably positioned into a corrosion coupon holding structure in a shape so that the angle between the corrosion coupons in x-y dimensions is 90°.

The latter embodiment is the mostly preferred embodiment.

### Process

Further, the present invention relates to a process for testing corrosiveness of liquid feedstock comprising the following steps:
a) pre-treating the liquid feedstock;
b) treating the pre-treated liquid feedstock at elevated temperature;
c) separating a liquid portion of the treated liquid feedstock from a vaporous portion of the treated liquid feedstock at a temperature lower than the elevated temperature of treatment step b);
d) analysing the amount of corrosive species in the liquid portion of the treated liquid feedstock and optionally in the vaporous portion of the treated liquid feedstock; wherein
e) in one or more of process steps a) to d) the liquid feedstock is contacted with one or more corrosion coupons and
f) after a testing cycle the weight loss of the one or more corrosion coupons is measured.

Preferably, a predetermined flow rate of liquid feedstock is used in the process of the present invention.

The liquid feedstock is preferably preheated to a predetermined in the pre-treatment step a).

In the pre-treatment step a) the liquid feedstock can be mixed with other components such as a gas feed or a reactants feed when appropriate.

The liquid feedstock can be mixed with the other components either before or after pre-heating the liquid feedstock.

The pre-treated, preferably preheated, liquid feedstock is then treated at elevated temperature. The treatment step can either be a non-reactive treatment step at elevated temperature or a reactive treatment step at elevated temperature.

A reactive treatment step is preferably carried out in the presence of a catalyst.

It is preferred that in the treatment step b) sulphur containing species comprises in the liquid feedstock are treated at elevated temperature.

Preferably the feedstock is treated at elevated temperature and elevated pressure.

After separating a liquid portion of the treated liquid feedstock from a vaporous portion of the treated liquid feedstock at a temperature lower than the elevated temperature of treatment step b) the liquid portion of the treated liquid feedstock is preferably stored.

The vaporous portion of the treated liquid feedstock is preferably again subjected to a separation step in which again a liquid portion is separated from a vaporous portion of the vaporous portion of the treated liquid feedstock.

Said liquid portion is preferably combined with the liquid portion of the treated liquid feedstock.

The liquid portion of the treated liquid feedstock is preferably analysed in regard of the amounts of total sulphur and of various types of sulfur compounds such as mercaptans, sulphides, disulfides, thiophenes, benzothiophenes, dibenzothiophenes etc. in the liquid portion of the treated liquid feedstock.

The vaporous portion of the treated liquid feedstock, preferably after the optional second separation step, is preferably analysed in regard of the total amount of gas feed.

Further, the vaporous portion of the treated liquid feedstock, preferably after the optional second separation step, is preferably analysed in regard of the amount of gaseous sulphur species such as H₂S.

The vaporous portion of the treated liquid feedstock, preferably after the optional second separation step, can further be treated in a flue gas sweetening step as to remove H₂S from the vaporous portion of the treated feedstock.

In one or more of process steps a) to d), preferably all of process steps a) to d) the liquid feedstock is contacted with one or more corrosion coupons.

Preferably, two or more corrosion coupons are removably positioned into a corrosion coupon holding structure which extends in x-, y- and z-direction as such that the two or more corrosion coupons are fixed at the same height in z-direction and are arranged at different angles in x- and y-directions and the liquid feedstock is contacted with the two or more corrosion coupons in the at least one corrosion coupon holding structure in one or more, preferably all, of process steps a) to d).

The corrosion coupon holding structure preferably is as defined above.

After a testing cycle the weight loss of the one or more corrosion coupons is measured.

It is further preferred that in addition to the weight loss measurement the one or more corrosion coupons are visually inspected and damages on the corrosion coupons are recorded.

The process of the present invention as described above and below is especially suitable to be carried out in the apparatus of the present invention as described above and below.

The liquid feedstock used in the apparatus and the process according to the invention as described above or below is preferably selected from whole crude oil or whole condensate feedstock or from different fractions of distilled crude oil or condensate, such as naphtha, jet fuel, light gas oil, heavy gas oil or fuel oil.

The other components optionally used in the apparatus and the process according to the invention as described above or below are preferably selected from inert feed gas, such as nitrogen, reactive feed gas, such as hydrogen, or other reactants used in the chemical engineering processes of a refinery unit.

The corrosion coupons used in the apparatus and the process according to the invention as described above or below are preferably made from metallic materials and alloys such all carbon steel grades, all alloy steel grades, stainless steel grades, nickel steel grades and other alloys which can be used as material in pipes and treatment units in the chemical engineering processes of a refinery unit.

The apparatus and process of the present invention as described above and below are especially suitable for simulating corrosion phenomena in all kinds of chemical engineering processes of a refining or petrochemical unit such as e.g. crude distillation, condensate distillation, hydrotreating, catalytic reforming, mercaptan oxidizing (merox), hydrocracking, catalytic cracking, amino gas treating, alkylation, isomerization, visbreaking and coking.

The apparatus and process of the present invention as described above and below are especially suitable for predicting corrosion hot-spots in refinery units and for analysing measures to reduce corrosion in these hot-spots, by e.g. analysing metallic materials which are corrosion resistant for the specific feedstock of the accordant process.

The apparatus and process according to the present invention are further described in more detail below in the description of the figures.

### DESCRIPTION OF FIGURES

### Reference Signs

A feed preparation section

A-1 feed tank for liquid feedstock

A-2 surge tank for feed gas or reactant

A-3 preheater

A-4 flow controller

B feed treatment unit

B-1 reactor

B-2 packing

B-3 heater block

C separating unit

C-1 separator

C-2 product vessel

C-3 knock-out drum

D product analysis section

D-1 back pressure regulator

D-2 flowmeter

D-3 flue gas sweetener

### Coupon Positioning

1+2 crude oil/condensate pre-heating train or reactor charge heater

3 pre-heating train or reactor charge heater effluent

4+5 refinery reactor (e.g. hydrotreater, hydrocracker, reformer etc)

6 reactor effluent

7 reaction products separation column

8 separator overheads section

9 flue gas sweetener feed

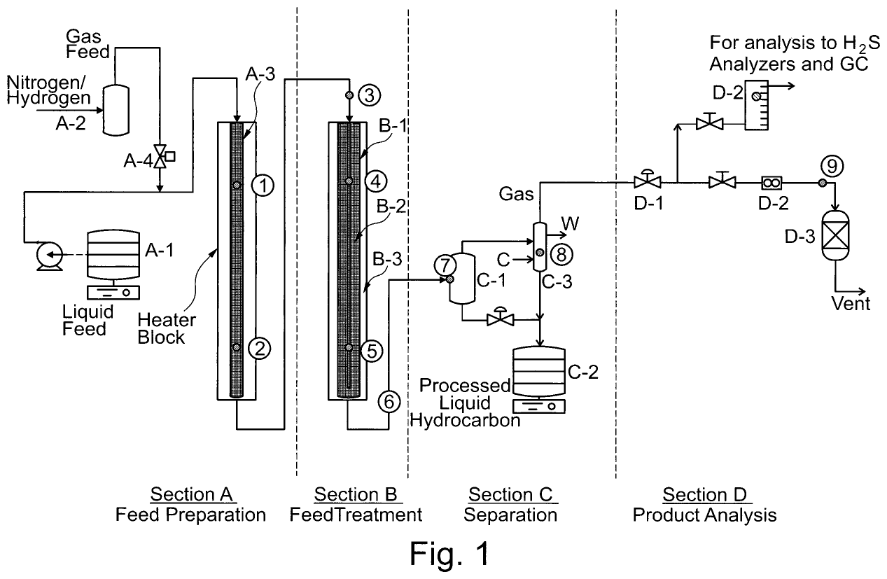

### FIG. 1

FIG. 1 shows a diagrammic view of an apparatus for testing corrosiveness of liquid feedstock according to the invention illustrating the different sections which simulate the chemical engineering processes of a petroleum refinery unit and showing the different spots for placing corrosion coupons.

Depending on the process to be simulated the liquid feedstock is selected. Liquid feedstocks which can suitably been tested in the apparatus of the present invention can be selected from whole crude oil or condensate feedstock or from all fractions from crude oil and condensates distillation.

The apparatus of the present invention is suitable to simulate the crude distillation unit or condensate distillation unit or all kinds of processing units of a refining unit such as downstream of the crude oil or condensates distillation such as e.g. hydrotreating units, catalytic reforming units, mercaptan oxidizing (merox) units, hydrocracking units, catalytic cracking units, amino gas treaters, alkylation units, isomerization units, visbreaking units and coking units.

For simulating these different processes the reactor is packed with a specific packing (optionally including a catalyst specific for catalysing the accordant process) and the feedlines of reactants is adjusted as to introduce e.g. specific reactants such as hydrogen for hydrotreating or hydrocracking into the feedline at the required positions of the process (e.g. before entering the preheater, between the preheater and the reactor or in counterflow with the liquid feedstock feed in the reactor).

The setup consists of four sections namely the feed preparation section (A), the feed treatment section (B), the separation section (C) and the product analysis section (D).

### Feed Preparation Section (A)

The liquid feedstock is weighed using a highly accurate balance. It is preheated to a set temperature as per requirement before mixing with a feed gas (diluent gas, e.g. nitrogen, in the case of non-reactive heat treatment, or a reactive gas, e.g. hydrogen, in the case of reactive heat treatment) in the preheating zone (A-3). The feed gas, on the other hand, is metered using a calibrated mass flow controller (A-4) and also preheated to the set temperature.

### Feed Treatment Section (B)

The feed is introduced to the isothermal feed treatment tube (B-1). The gas could be introduced concurrently or countercurrently in to the feed treatment tube. The liquid hydrocarbon feed can be introduced either in upflow mode or downflow mode, depending on hydrodynamic considerations to maintain stable operations and intimate contact between the gas and liquid phases. The feed treatment tube is further filled with packings (B-2) of appropriate material (non-reactive packing for a non-reactive heat treatment or a catalyst for the case of a reactive heat treatment). The packing will also ensure that the flow is evenly distributed along the feed treatment zone.

The feed treatment tube (B-1) temperature is maintained at the desired level with high accuracy using precisely controlled electric heater blocks (B-3). Process fluid temperature inside the heated tube is monitored by three thermocouples located at different locations of the heated zone (not shown). Pressure is controlled via a back pressure regulator (D-1) located downstream of the knock-out drum (C-3) in the separation section.

### Separation Section (C)

The feed treatment tube (B-1) effluent is sent immediately to the separator (C-1), whose temperature is maintained at a set low temperature. The liquid portion is collected in the product vessel (C-2) to be weighed while the gas is sent to a knock-out drum (C-3) (also maintained at a pre-set low temperature, in case any liquid might have been carried over).

### Product Analysis Section (D):

The liquid product is analyzed in the laboratory for total sulfur and mercaptans sulfur at the end of each experiment. The setup is also configured adequately for the analysis of the gas product. A pressure control valve (D-1) in the off-gas line controls the system pressure, while the gas volumetric flow rate is metered using a wet gas meter (D-2). The concentration of H₂S leaving the heat treatment section is precisely calculated using material balance.

### Corrosion Coupons

Rightly sized corrosion coupons are located securely with different orientations (to reflect various hydrodynamic conditions) at the different locations in the setup in contact with the process fluids. Corrosion coupon testing in the feed treatment section will be representative of the process fluid corrosivity in the crude/condensate preheat trains, or in the preheat sections of hydrotreating or reactor units in refineries. Corrosion coupons positioned inside the feed treatment tube (B-1), in the separator (C-1), and inside the knock-out drum (C-3) will be representative of corrosion testing inside the hydrotreater reactor, separator columns and in the overhead section of the separator columns in the refinery.

### Corrosion Coupon Weight Loss

Rate of corrosion for the different zones in a refinery can be quantified from analysis of the weight loss coupons

### Corrosion Coupon Examination

Stress corrosion cracking, crevice and pitting and general corrosion etc., by visual and other microscopic techniques at higher magnifications.

### Quantification Of H₂S In The Process Stream

The concentration of H₂S in the process stream can be quantified by effective material balance. This can be correlated accurately to the corrosion rate of the coupons quantified from the weight loss.

FIG. 1 provides details about placement of the corrosion coupons, indicated in by the numbers 1-9. These locations have been further listed correspondingly for testing refinery streams as below:

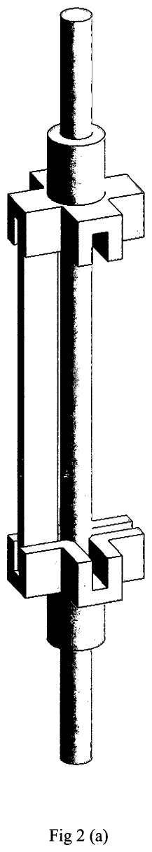

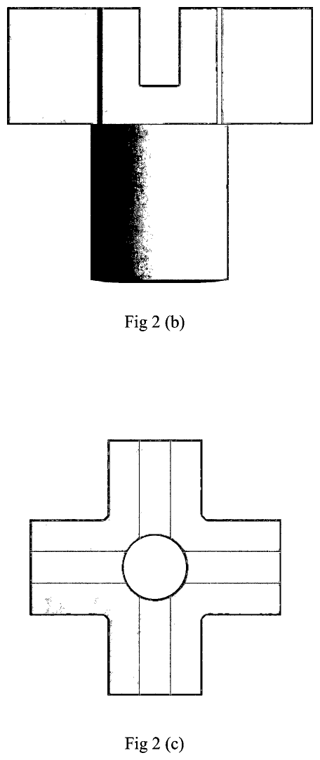

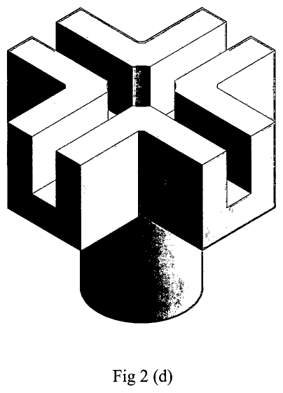

FIG. 2

| Coupon | | Corrosion |
|---|---|---|
| # | Refinery Stream | Phenomenon |
| 1 | Crude/condensate preheat trains or | High temperature |
| | refinery change heaters | corrosion |
| 2 | Crude/condensate preheat trains or | High temperature |
| | refinery change heaters | corrosion |
| 3 | Preheat train/Charge heaters effluent | High temperature |
| | stream | corrosion |
| 4 | Refinery reactor, e.g. Hydrotreater, | High temperature |
| | Hydrocracker, Reformer etc. | corrosion |
| 5 | Refinery reactor, e.g. Hydrotreater, | High temperature |
| | Hydrocracker, Reformer etc. | corrosion |
| 6 | Refinery reactor effluent stream | High temperature |
| | | corrosion |
| 7 | Reaction products separation column | Aqueous corrosion |
| 8 | Separators overheads section | Ammonium Chloride/ |
| | | Bisulfide corrosion |
| 9 | Flue gas sweetener feed | Aqueous corrosion |

FIG. 2 shows an example for a corrosion coupon holding structure suitable for positioning corrosion coupons into the apparatus of the present invention as illustrated in FIG. 1. The present example of a corrosion coupon holding structure is suitable for attaching four coupons of the dimensions 10 mm×5 mm×50 mm.

The coupon holding structure includes an upper and a lower holding unit into which the coupons are placed and secured in the shape of a cross so that the angle in x-y dimensions is 90°.

The coupon holding structure is dimensioned as such as it can be placed and secured into the different sections of the apparatus shown in FIG. 1. The coupon holding unit ensures that the corrosion coupons are securely placed with different orientations (to reflect various hydrodynamic conditions) at the different locations in the setup in contact with the process fluids.

Apart from the exemplary corrosion coupon holding structure shown in FIG. 2 other designs with different angles are possible in which e.g. a different number of corrosion coupons such as e.g. 2, 3, 4, 5, 6 or even more coupons are placed.

1. An apparatus for testing corrosiveness of liquid feedstock comprising:
a feed preparation section (A) for pre-treating the liquid feedstock;
a feed treatment section (B) downstream the feed preparation section (A) for treating the pre-treated liquid feedstock at elevated temperature;
a separation section (C) downstream the feed treatment section (B) for separating a liquid portion of the treated liquid feedstock from a vaporous portion of the treated liquid feedstock at a temperature lower than the elevated temperature of the feed treatment section (B);
a product analysis section (D) downstream the separation section for analysing the amount of corrosive species in the liquid portion of the treated liquid feedstock and optionally in the vaporous portion of the treated liquid feedstock;
a plurality of feeding lines for conveying the liquid feedstock from the feed preparation section (A) to the feed treatment section (B) to the separation section (C) and to the product analysis section (D); and
one or more corrosion coupons (1-9);
wherein the one or more corrosion coupons (1-9) are removably placed into one or more of the feed preparation section (A), the feed treatment section (B), the separation section (C) and/or the product analysis section (D) as such that the one or more corrosion coupons are in contact with the liquid feedstock during operation of the apparatus.

2. The apparatus according to claim 1, wherein the feed preparation section (A) comprises a vessel (A-1) for storing liquid feedstock, a vessel (A-2) for storing further components, means (A-3) for mixing and preheating the liquid feedstock and the further components and means (A-4) for controlling the flow rate of the further components.

3. The apparatus according to claim 1, wherein the feed treatment section (B) comprises an isothermal treatment unit (B-1), means for controlling the temperature in the isothermal treatment unit (B-3), and means for controlling the pressure in the isothermal treatment unit (D-1).

4. The apparatus according to claim 3, wherein the isothermal treatment unit (B-1) is filled with a packing (B-2) for evenly distributing the pre-treated liquid feedstock along the isothermal treatment unit (B-1).

5. The apparatus according to claim 4, wherein the packing (B-2) includes a catalyst for catalytically treating the liquid feedstock.

6. The apparatus according to claim 1, wherein the separation section (C) includes at least one separating unit (C-1).

7. The apparatus according to claim 1, wherein two or more corrosion coupons are removably positioned into a corrosion coupon holding structure which extends in x-, y- and z-direction as such that the two or more corrosion coupons are fixed at the same height in z-direction and are arranged at different angles in x- and y-directions and at least one corrosion coupon holding structure is removably placed into one or more of the feed preparation section (A), the feed treatment section (B), the separation section (C) and/or the product analysis section (D) as such that the two or more corrosion coupons in the corrosion coupon structure are in contact with the liquid feedstock during operation of the apparatus.

8. A process for testing corrosiveness of liquid feedstock comprising the following steps:
a) pre-treating the liquid feedstock;
b) treating the pre-treated liquid feedstock at elevated temperature;
c) separating a liquid portion of the treated liquid feedstock from a vaporous portion of the treated liquid feedstock at a temperature lower than the elevated temperature of treatment step b);
d) analysing the amount of corrosive species in the liquid portion of the treated liquid feedstock and optionally in the vaporous portion of the treated liquid feedstock;
wherein
e) in one or more of process steps a) to d) the liquid feedstock is contacted with one or more corrosion coupons and
f) after a testing cycle the weight loss of the one or more corrosion coupons is measured.

9. The process according to claim 8, wherein in the pre-treatment step the liquid feedstock is mixed with other components.

10. The process according to claim 8, wherein in treatment step sulphur containing species in the pre-treated liquid feedstock are treated at elevated temperature.

11. The process according to claim 10, wherein the sulphur containing species in the pre-treated liquid feedstock are treated in the presence of a catalyst.

12. The process according to claim 8, wherein two or more corrosion coupons are removably positioned into a corrosion coupon holding structure which extends in x-, y- and z-direction as such that the two or more corrosion coupons are fixed at the same height in z-direction and are arranged at different angles in x- and y-directions and the liquid feedstock is contacted with the two or more corrosion coupons in the at least one corrosion coupon holding structure in one or more of process steps a) to d).

13. The process according to claim 8, wherein after a testing cycle the one or more corrosion coupons are visually inspected and damages are recorded.

14. The process according to claim 8, wherein the liquid feedstock is selected from different fractions of distilled crude oil, the feed gas is selected from inert feed gas such as nitrogen and reactive feed gas such as hydrogen and the one or more corrosion coupons are made from metallic materials.

15. (canceled)
